(19) United States
(12) Patent Application Publication
(10) Pub. No.: US 2008/0279447 A1
(43) Pub. Date: Nov. 13, 2008

(54) Computational Solution Of A Building Of Three Dimensional Virtual Models From Aerial Photographs

(75) Inventors: Ilan Friedlander, Netanya (IL); Haim Shoham, Netanya (IL)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(73) Assignee: OFEK AERIAL PHOTOGRAPHY INTERNATIONAL LTD., Netanya (IL)

(21) Appl. No.: 11/576,150

(22) PCT Filed: Oct. 16, 2005
(86) PCT No.: PCT/IL05/01095

§ 371 Date: Mar. 28, 2007

Related U.S. Application Data
(60) Provisional application No. 60/618,578, filed on Oct. 15, 2004.
(60) Provisional application No. 60/659,084, filed on Mar. 8, 2005.

(51) Int. Cl. G06K 9/00

(52) U.S. Cl. 382/154

(57) ABSTRACT

A method for processing in a computer a plurality of digital images stored in the computer. The digital images are from respective photographs (301) of a geographic region. The photographs were taken from different directions. The method includes displaying the images (311) and upon selecting an image point in an oblique image, synchronizing a corresponding image point in the digital images so that the selected image point in the first image and the corresponding synchronized image point in other images have substantially identical world coordinates. The method is useful for performing a geographic measurement (319) on an oblique by selecting an image ground point below a first image point; calculating world coordinates in a vertical line segment which extends vertically from the image ground, and upon selecting the first image point on the vertical line segment, calculating world coordinates at the first image point based on the world coordinate in the vertical line segment.

### FIELD AND BACKGROUND OF THE INVENTION

The present invention relates to using photogrammetric techniques for providing measurements on two dimensional oblique photographs and three dimensional models based on two dimensional oblique photographs.

Conventionally, mapping of land is achieved with the use of orthogonal photography, with the camera pointing orthogonally downward towards the ground. Orthogonal photographs are easily scaled to provide horizontal distance measurements. However, orthogonal photographs are not sufficient for topographical measurements or measurements of heights since sufficient elevation information is not available. Additional methods are used for attaining elevation information such as radar, or surveying in combination with orthogonal photography. Height information is typically stored in a computer as a digital terrain model. The combination of a elevation measurements with orthogonal aerial photography is conventionally used to build a topographical map. Representative prior art references in the field of mapping land include U.S. Pat. No. 4,686,474 and U.S. Pat. No. 5,247,356.

Photogrammetry is a measurement technology in which the three-dimensional coordinates of points on a three dimensional physical object are determined by measurements made in one or more photographic images. The technique is used in different fields, such as topographic mapping, architecture, engineering, police investigation, geology and medical surgery. Photogrammetric techniques require that photogrammetric images be taken at an oblique angle to provide elevation information. The challenge of photogrammetry arises from the fact that oblique photographs are not easily scaled. For instance, images of buildings in the foreground of an oblique photograph appear to be much larger than similar buildings in the background of the the same image.

Reference is now made to FIG. 1 a prior art drawing showing coordinate axes 10 in a photogrammetric calculation. Coordinates X and Y represent geographic coordinates, e.g. distances on the horizontal plane parallel to the ground. Coordinate Z for represents elevation, for instance above sea level (z=0). A camera is located in position (X_{c},Y_{c},Z_{c}). Angular coordinates of the camera are given by angles of rotation Omega [Ω], Phi [φ], and Kappa [K or k]. Omega [Ω] is the angle of rotation about the X axis, Phi [φ] is the angle of rotation about the Y axis Kappa [K] is the angle of rotation about the Z axis. The term “camera coordinates” as used herein includes both the position coordinates (X_{c},Y_{c},Z_{c}) and the three angles of rotation. Ray 103a is a light ray which emanates from Point P(X,Y,Z) located on a physical object 105. Ray 103a enters the camera and is imaged on image plane 107 at a point P′(xₚ,yₚ). The focal length of the camera is typically known. Typically, photogrammetric cameras have low photographic distortion, and the distortion is known and is removed during subsequent calculation. Typically, aerial photography is performed at varying angles, usually between 20° and 70°, under the wing of the aircraft.

Photography can be carried out with a digital or analog metric camera, or a video camera or a simple camera which is not designed for photogrammetric measurements. In the case of a camera, using film, the photographs are scanned with an accurate photogrammetric scanner. In the case of a video camera, a video frame or an average of identical video frames are used for the photograph. The term “interior orientation” is used herein to denote the 2D affine coordinate transformation between two-axis systems, the photograph coordinate system (for instance measured in millimeters on the film) to the digital image coordinate system (in picture elements of known size) subsequent to scanning. The “interior orientation” is calculated as follows for film photography. For video other types of photography, the interior orientation is analogous:

We look for coefficients a₀,a₁,a₂ b_{0,b}₁,b₂ such that

xₚ=a₀·xᵢ+a₁·y₁+a₂, yₚ=b₀·xᵢ+b₁·y₁+b₂

where xᵢ,yᵢ is image coordinate, and xₚ,yₚ is matching photograph coordinate
The operator marks at least three fiducial marks on the image, and inputs the corresponding coordinates of the photograph coordinate system. If there are more then three fiducial marks, a least square adjustment may be used. The operator integrates the calibration report including the camera lens distortion with the orientation solution.

The term “exterior orientation” is used to solve the camera coordinates, the camera position (X_{c},Y_{c},Z_{c}) and the three orientation angles Omega, Phi and Kappa of the camera when the photograph was taken. The operator inputs the focal length of the camera f. The operator selects at least three ground control points on the oblique digital image, and corresponding ground control points typically on a scaled orthogonal photograph or map for which world coordinates are known. Alternatively, the world coordinates of the three control points are provided by surveying. For each control point j selected, geographic coordinates Xtⱼ,Ytⱼ are typically obtained from the orthogonal photograph or map, and elevation Ztⱼ from a digital terrain model previously stored in the computer.

We need to solve the collinearity (CE) equations:

$${x}_{p} = {x}_{0} - f \frac{{m}_{11} ( Xt - {X}_{c} ) + {m}_{12} ( Yt - {Y}_{c} ) + {m}_{13} ( Zt - {Z}_{c} )}{{m}_{31} ( Xt - {X}_{c} ) + {m}_{32} ( Yt - {Y}_{c} ) + {m}_{33} ( Zt - {Z}_{c} )}$$

$${y}_{p} = {y}_{0} - f \frac{{m}_{21} ( Xt - {X}_{c} ) + {m}_{22} ( Yt - {Y}_{c} ) + {m}_{23} ( Zt - {Z}_{c} )}{{m}_{31} ( Xt - {X}_{c} ) + {m}_{32} ( Yt - {Y}_{c} ) + {m}_{33} ( Zt - {Z}_{c} )}$$

xₚ,yₚ is photograph coordinate, Xt,Yt is physical object coordinate in world space.
x₀,y₀ is taken from camera calibration report, or calculated by fiducials coordinates.

And M is matrix:
m₁₁=cos φ cos k
m₁₂=sin Ω sin φ cos k+cos Ω sin k
m₁₃=−cos Ω sin φ cos k+sinΩ sin k
m₂₁=−cos φ sin k
m₂₂=−sin Ω sin φ sin k+cos Ω cos k
m₂₃=cos Ω sin φ sin k+sin Ω cos k
m₃₁=sin φ
m₃₂=−sin Ω cos 100
m₃₃=cos Ω cos φ
   There are six unknown parameters or camera coordinates to solve, each time the operator selects a ground control point on the oblique image and on the orthogonal photograph two equations are formed, thus three ground control points are required to solve for all the unknown parameters.

The calculation proceeds with a linearization of the equations using a Taylor expansion, first guessing initial values for the six unknowns and iteratively solving the linearized equations using a least square adjustment, trying to improve the results for the 6 unknown parameters until a previously defined threshold is reached. After a solution is reached, the solution is typically checked by the accuracy report (residuals), changing/sampling of additional control points and physically checking of several points chosen at random, in order to check orientation accuracy by pointing to the orthogonal photograph and checking the accuracy of the pointing on the oblique photograph.

Prior art photogrammetric solutions using oblique aerial photography used digital terrain models (DTM) based on a Triangulated Irregular Network (TIN) model. The TIN model was developed in the early 1970's as a simple way to build a surface from a set of irregularly spaced points. The irregularly spaced sample points can be adapted to the terrain, with more points in areas of rough terrain and fewer in smooth terrain. An irregularly spaced sample is therefore more efficient at representing a surface. In a TIN model, the sample points are connected by lines to form triangles. Within each triangle the surface is usually represented by a plane. By using triangles each piece of the mosaic surface will fit with neighboring pieces. The surface will be continuous, as each triangle's surface would be defined by the elevations of the three corner point.

Another type of digital terrain model is a raster digital terrain model The raster DTM is typically a rectangular grid over a certain area and resolution. Each pixel in the raster “covers” an area of r×r [m²] in world space, and has a gray value that represents the height of the terrain in the middle of this square.

In prior art photogrammetric solutions for oblique aerial photography, after the camera coordinates are determined an operator is able to select geographic coordinates on the orthogonal map or photograph and obtain the corresponding image coordinates or photograph coordinates by solving the CE equations with a single query to the stored TIN DEM.

Measurement capability in prior art photogrammetric solutions for oblique aerial photography is limited. Reference is now made to FIG. 2 which illustrates a horizontal distance measurement of the prior art. In FIG. 2, selecting an image point 201 on an entity 203, e.g. image of building determines and calculates a ray 103 from camera position 101 to the physical point corresponding to image point 201. The geographic coordinates used for the measurement (and for obtaining elevation from the DTM) are from point 205 where ray 103 intersects the terrain. For oblique angles, close to orthogonal, this method of calculation is reasonably accurate. However, for other angles, prior art methods introduce errors. For instance for measuring a horizontal measurement along the roof of a building, ray 103 intersects the ground several meters from the foot of the building. The measured horizontal distance H is based on the ground distance where ray 103 intersects the ground and the measurement is in error due to perspective distortion and to actual differences in elevation between the real point where ray 103 strikes the ground and the foot of the building.

There is thus a need for, and it would be highly advantageous to have a method of for more accurately measuring distances on oblique images than is provided for in the prior art. Furthermore, it would be advantageous to have a method which references world coordinates from one oblique photographs to other photographs including oblique photographs taken of the same region but from different directions. Moreover, there is a need for and it would be advantageous to have a method for building three dimensional objects based on accurate metrological techniques so that the three dimensional objects are viewed and manipulated in a separate display window and/or exported to other computer applications in a standard format. Furthermore, there is a need for and it would be advantageous to have a method for cropping facades from oblique photographs and incorporating the facades with the three dimensional objects as virtual three dimensional models of physical objects.

### REFERENCES

http://en.wikipedia.org/wiki/Photogrammetry

The term “geographic coordinates” as used herein refers to a pair of coordinates, position coordinates or angular coordinates, e.g. latitude and longitude, which determine a geographic location, typically on the surface of the planet Earth. The term “geographic region” or “region” as used herein includes man-made physical objects, such as buildings and roads. Similarly the term “geographic measurements” includes measurements of man-made physical objects as well as natural terrain. The term “world coordinates” or “three-dimensional coordinates” as used herein refers to geographic coordinates and a third coordinate, e.g. elevation, which determine a position on or above the surface of the Earth or any other world. The term “oblique” as used herein refers to a direction which is not a principal axis of a physical object being photographed, typically not orthogonal nor parallel to the ground. The term “physical object” refers to an object in real space such as a building. The term “object” or “three-dimensional object” as used hereinafter refers to a virtual object such as a data structure e.g. vector object which overlays in part an image of a physical object. The term “entity” or “three dimensional entity” is used herein to refer to at least a portion of an image of a physical object. The term “below” as used herein refers to a projection to lower elevation. For example, a point (X,Y,0) is below (X,Y,Z). The term “display over an image” as used herein refers to display as a layer over a digital image. In the present invention an “object” is displayed as a layer over an entity. The term “photography” or “photograph” as used herein includes any type of photography used in the art including film, digital photography, e.g. CCD, and video photography. The terms “digital terrain model” and “digital elevation model” are used herein interchangeably.

### SUMMARY OF THE INVENTION

According to the present invention there is provided a method for processing in a computer digital images stored in the computer. The digital images are derived from respective photographs of a geographic region. The photographs were photographed from a number of directions. A first image is displayed which corresponds to a first photograph which was photographed at an oblique angle. Another digital image is simultaneously displayed of the same region. Upon selecting an image point in the first image, a corresponding image point is synchronized in the other digital image. The selected image point in the first image and the corresponding synchronized image point in the other image have identical world coordinates. Preferably, prior to the synchronization for at least one of the respective digital images, camera coordinates are calculated of the photographs based on three or more control points in the respective digital images. The geographic coordinates of control points are previously known Alternatively, world coordinates are simultaneously calculated for the image point and the corresponding image point. Preferably, an exportable object is created by selecting other image points in one or more of the displayed digital images. Preferably, synchronizing includes iteratively estimating geographic coordinates of the selected image point, an estimated elevation value is received from a digital elevation model of the region based on the estimated geographic coordinates. The digital elevation model is previously stored in memory of the computer, and respective camera coordinates of the first photograph and the other photograph are previously determined. Preferably, a raster digital elevation model is stored in memory of the computer. Upon inputting any geographic coordinates to the raster digital elevation model, the raster digital elevation model returns a corresponding elevation value. Preferably, prior to the synchronization of one of the digital images, three or more control points are selected in the digital images, and respective geographic coordinates of the control points are previously determined. Respective elevation values are obtained from the raster digital elevation model. Camera coordinates are calculated of the camera which photographed the photographs based on the control points. Preferably, a photograph direction is determined of one or more digital images, the photograph direction is determined by a vector between a camera position of the digital image to the selected image point; and digital images are chosen based on comparing a geographic direction to the photograph direction. Preferably, a a measurement is performed in one or more displayed images between a first image point and a second image point, by selecting an image ground point below the first image point; calculating at least one world coordinate in a vertical line segment, and the vertical line segment extends vertically from the image ground point. Upon selecting the first image point on the vertical line segment, a world coordinate is calculated at the first image point based on world coordinate in the vertical line segment. Preferably, when the measurement is a horizontal distance measurement, the second image point is selected to calculate geographic coordinates of the second image point. Preferably, when the measurement is a vertical distance measurement, the second image point is selected to calculate an elevation of the second image point. Preferably, when the selected image point is on a three dimensional entity at least partially visible in the first image, and different views from different directions of the three dimensional entity are displayed, image points are selected on the three dimensional entity in the different views, thereby synchronizing the other image points in the displayed images, and a three dimensional object is displayed.

According to the present invention, there is provided a method for performing a measurement related to an image point in a digital image using a computer which stores and displays the digital image. The digital image was derived from a photograph taken at an oblique angle. An image ground point below the first image point is selected and one or more world coordinates are calculated in a vertical line segment which extends vertically from the image ground point. Upon selecting the first image point on the vertical line segment, at least one world coordinate is calculated at the first image point based on the world coordinate in the vertical line segment. Preferably, the vertical line segment is displayed over the displayed image. Preferably, the calculation includes iteratively estimating geographic coordinates, an estimated elevation value is received from a digital elevation model based on the estimated geographic coordinates, the digital elevation model is previously stored in memory of the computer, and respective camera coordinates of the photograph are previously determined. Preferably, upon selecting a second image point related to the measurement, at least one world coordinate is calculated of the second image point.

According to the present invention there is provided a method for building three dimensional models in a computer, wherein digital images are stored in the computer. The digital images are derived from respective photographs of a geographic region from a number of directions. Displayed digital images are chosen from the stored digital images and simultaneously displayed. The displayed digital images each include at least a partial view from a different direction of a three dimensional entity. Image points are selected on the three dimensional entity in one or more of the displayed digital images thereby synchronizing other image points in other displayed digital images, and a three dimensional object is displayed. Preferably, the image points are vertices of facades of the three dimensional object, the three dimensional object is built while preserving connectivity of the facades from two or more of the displayed digital images. Preferably, the image points include a plurality of vertices of the facades of the three dimensional entity. The facade are cropped as respective polygons with the vertices, by calculating world coordinates respectively of the vertices. The facades are pasted onto the three dimensional object to incorporate the facade in the three dimensional object. Preferably. the three dimensional object is exported to a new display window, another application of the computer or to a standard format. Preferably, for at least one of the image points, an image ground point is selected below the image point, a world coordinate is calculated in a vertical line segment which extends vertically from the image ground point. Upon selecting the image point on the vertical line segment, a world coordinate is calculated at the image point based on the world coordinate in the vertical line segment. Preferably, for at least one of the image points, geographic coordinates are iteratively estimated, an estimated elevation value is received from a digital elevation model of the region based on the estimated geographic coordinates, the digital elevation model is previously stored in memory of the computer, and respective camera coordinates of said photographs are previously determined.

According to the present invention there is provided, a program storage device readable by a machine, tangibly embodying a program of instructions executable by the machine to perform a method for performing the methods as described herein.

### BRIEF DESCRIPTION OF THE DRAWINGS

The invention is herein described, by way of example only, with reference to the accompanying drawings, wherein:

FIG. 1 is a prior art drawing of coordinate systems used in photogrammetric calculations

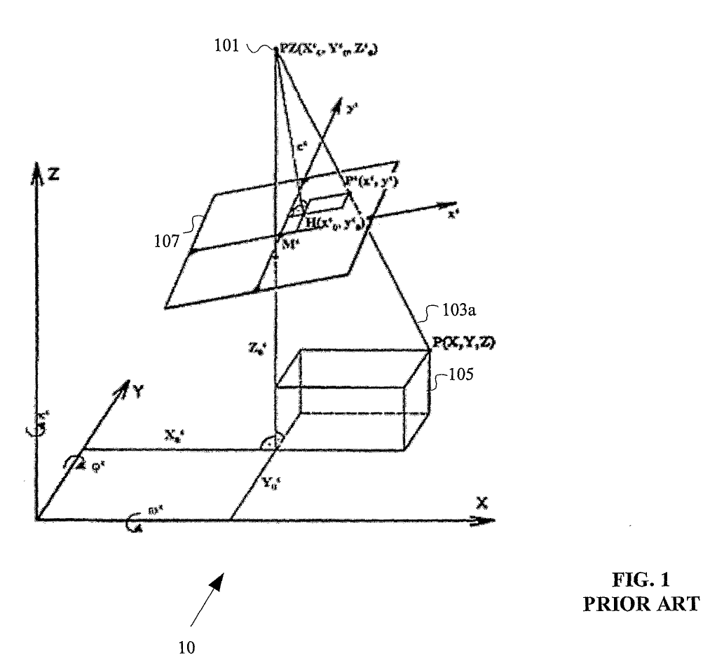

FIG. 2 is an illustration of a prior art measurement method.

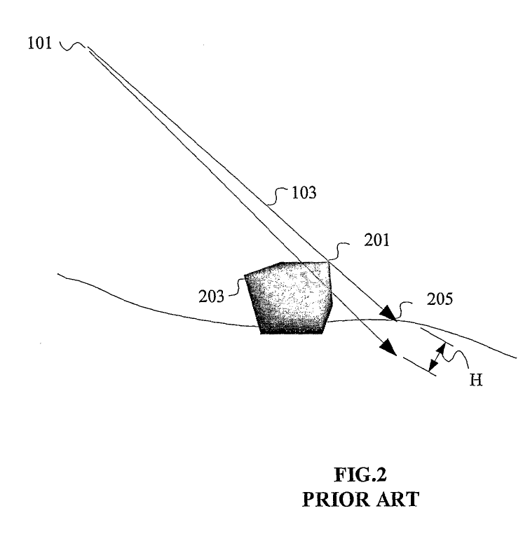

FIG. 3 is a flow diagram of a method according to embodiments of the present invention;

FIG. 4a is a simplified drawing of an image an orthogonal map as displayed on a computer display;

FIG. 4b is a second view of the computer display after oblique images are selected, according to an embodiment of the present invention;

FIG. 5 illustrates a method for choosing oblique photographs, according to an embodiment of the present invention;

FIG. 6 is a simplified view of a computer display illustrating a method for building three dimensional models and cropping facades, according to an embodiment of the present invention; and

FIG. 7 is an illustration of a cropped facade, according to an embodiment of the present invention.

### DESCRIPTION OF THE PREFERRED EMBODIMENTS

The present invention is of a system and method for providing measurements and three dimensional models based on two dimensional oblique photographs. Specifically, the system and method includes a photogrammetric computational solution combined preferably with a raster digital elevation model. The use of a raster digital elevation model as opposed to a TIN model, for instance, allows retrieving of elevation values rapidly without undue computational overhead making it possible to rapidly reference world coordinates from one oblique photograph to another of the same region. Once different views of the same region are registered together on the same display, the operator may build three dimensional virtual models of the entities visible in the oblique images.

It should be noted, that although the discussion herein relates to typically to photography of resolution of about 1 meter and digital terrain models of resolution of tens of meters, the present invention may, by non-limiting example, alternatively be configured as well using a different range, a higher or a lower range of resolutions.

Before explaining embodiments of the invention in detail, it is to be understood that the invention is not limited in its application to the details of design and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

By way of introduction, principal intentions of the present invention are: to provide a computerized method of choosing oblique digital images of a single geographic region from a large number of digital images of many typically adjacent and overlapping geographic regions stored in a memory of the computer. Once appropriate oblique photographs are chosen, another intention of the present invention is to provide a method for selecting a point in one of the displayed two dimensional oblique digital images and synchronize, in other displayed digital images, image points with the same world coordinates. Another intention of the present invention is to provide accurate measurement methods for horizontal, vertical, and air distance measurements on oblique digital images. Another intention of the present invention is to allow the operator to build virtual exportable objects of scaled dimensions which correspond accurately to the dimensions of the entities of interest in the oblique digital images. Another intention of the present invention is to crop facades from two or more of the oblique digital images and incorporate the facades with the three dimensional objects to build functional three dimensional virtual models of the physical objects originally photographed.

The present invention is applicable in many fields including tax assessment and building code violations, urban and infrastructure planning, land registry and management, military security, anti-terror and special forces operations, emergency and first response of emergency workers, critical infrastructure management such as of airports, seaports, mass transit terminals, power plants and government installations.

The principles and operation of a system and method of providing measurements and three dimensional modeling based on two dimensional oblique photographs, according to the present invention, may be better understood with reference to the drawings and the accompanying description.

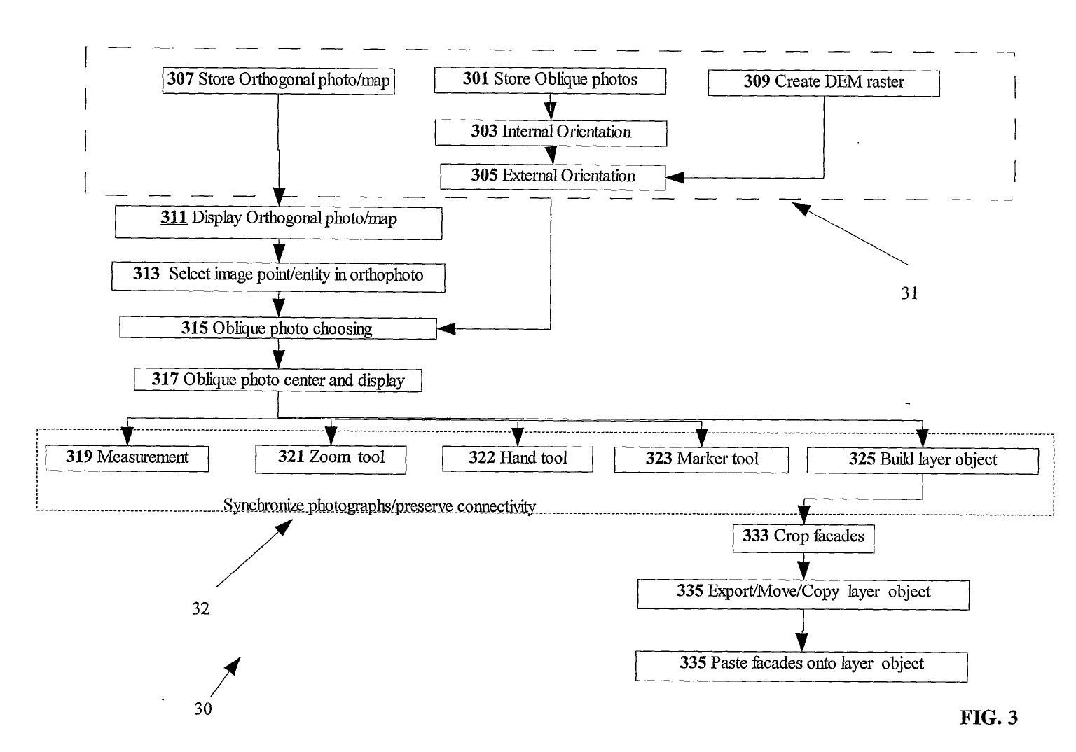

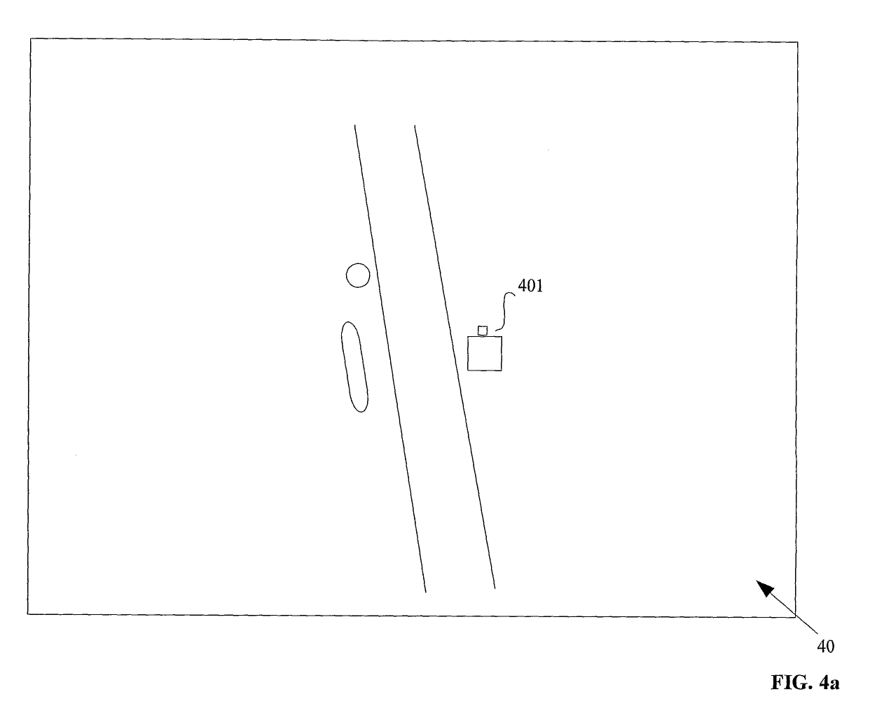

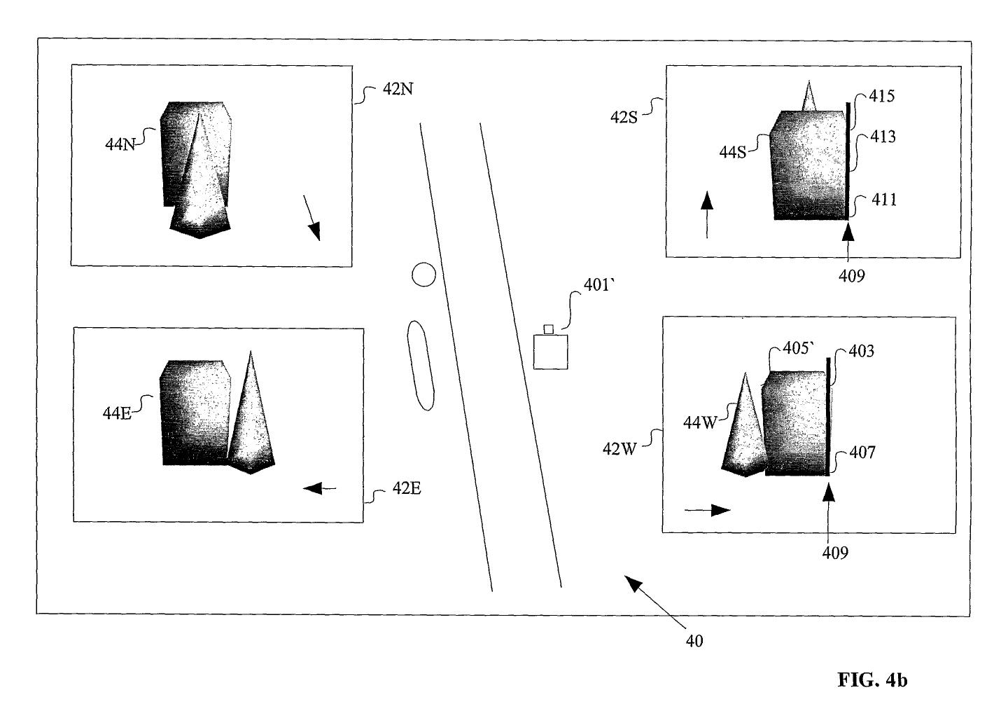

Referring now to the drawings, FIG. 3 is a flow diagram of a process 30 illustrating several embodiments of the present invention. Process 30 begins with storing oblique photographs (step 301) in memory of a computer. Typically, the number of stored oblique photographs may exceed several hundred thousand. A digital elevation model (DEM) is stored (step 309). Preferably, the DEM is a raster DEM. Typically, a conventional map or orthogonal photographs of the same geographic region is also stored (step 307) in the computer. The oblique photographs, whether generated using traditional film photography or using digital photography are internally oriented (step 303) and externally oriented (step 305) for instance as previously described. Steps 301-309 are included as part of pre-processing (step 31) required for embodiments of the present invention. Reference is now also made to FIGS. 4a and 4b, which illustrate embodiments of the present invention. Once pre-processing 31 is complete, an operator using an application, preferably installed on the computer using a program storage device, displays (step 311) on a computer display attached to the computer, a portion of map or orthogonal photograph 40 of interest. The operator is interested in a point 401 of orthogonal photograph 40 and the operator selects point 401 using an input device attached to the computer, e.g. a mouse click. Particular oblique digital images 42N., 42S., 42E. and 42W. derived originally from oblique aerial photographs are chosen (step 315) from among the many, e.g 100,000 stored oblique images and displayed (step 317) preferably each in an individual display window on the computer display. Typically, digital images 42 are positioned (step 317) in the respective windows so that entities 44 with world coordinates corresponding to point 401 are in the center of the windows. Similarly orthogonal photograph 40 is preferably centered around point 401. The user may manipulate images 42 using a zoom (step 321) hand tool (step 322) and/or marker tool (step 323). Zoom (step 321) magnifies the image within the window and the hand tool (step 322) shifts image 42 within the window. Marker tool (step 323) is used, for instance, by dragging mouse over one image 42 and synchronous changes occur in other images 42 that are displayed in the other windows.

According to embodiments of the present invention, an image point is selected in one of the displayed oblique images 42 and the application is required to synchronize, for instance to mark (step 323) corresponding image points in the other displayed images with the same world coordinates as the selected image point. Synchronization from oblique image 42 requires an inverse solution of the collinearity equations. The inverse solution is typically performed iteratively. When an image point is selected in oblique image 42, the interior orientation is used to obtain photograph coordinates (xₚ,yₚ). The photograph coordinates are used as a basis to estimate initial values for entity geographic coordinates (Xₜ,Yₜ) in world space. The estimated geographic coordinates are used to obtain an elevation value Zₜ from the stored DEM raster (step 309). The elevation value obtained from the DEM is then used to obtain a next iteration for geographic coordinates. Since the inverse solution process is iterative, there is an advantage to use a DEM raster, rather than for instance a DEM based on a TIN model, because using the TIN model requires interpolations to find each new elevation value and therefore the computation with a TIN based DEM is more time consuming. Since the TIN model is based on irregular points and for any particular set of geographic coordinates, considerable time is required to find the correct triangle that should be used to calculate the elevation coordinate.

### Digital Elevation Model (DEM) Raster (Step 309)

The DEM Raster image is used to calculate the elevation (Z) value of a given (X.Y) geographic coordinate, according to embodiments of the present invention. The raster dimensions depend on the desired geographic region and on the resolution desired by the operator. Each pixel in the raster “covers” an area of r×r [m²] in world space, and has a gray value that represents the height of the terrain in the middle of this square, When the gray value is lower, the shade is lighter and the elevation higher. The gray scale is chosen by the minimum and maximum elevations of the known terrain points. When there is a need to calculate the Z value for a specific X,Y coordinate, three pixels from the raster are chosen, in such a way that X.Y falls inside the triangle formed by the three pixels and these three pixels are the closest available points to X,Y. The elevation (Z) values of the three points are calculated from the respective gray values. Using the three points in 3D world space, namely x₁,y₁,z₁ x₂,y₂,z₂ x₃,y₃,z₃ a plane is determined. Two vectors are chosen between the points to form two vectors. A cross product computes the normal to the plane, and the elevation value of the requested (X,Y) is determined.

The DEM raster is created (step 309) based on a collection of known world coordinates, for example in ASCII file. The first step in the creation of the raster is to determine the raster borders and the desired resolution. The dimensions of the raster are then determined and an array in memory is allocated.

By iterating over the pixels in the raster, each pixel j,i is given a gray value based on the known points in the following way:

x,y world coordinate for the pixel is calculated by linear transformation using the width, height and resolution of the raster. The XY plane is divided into a number of pieces, for instance, eight pieces, and n closest points in each piece are determined, Good results are typically achieved by choosing n>3. Each point found is weighted with respect to its distance from point x,y and the weighted average is computed for obtain a z value. The z value is assigned to a value in gray scale and assigned to pixel j,i in the raster. An example of a weight function can be

$$\frac{1}{{e}^{d / 50}} ,$$

where d is the distance to x,y.

### Image Model:

The format of the stored digital information used is preferably Enhanced Compressed Wavelet (ECW), an image format that allows compression of imagery up to 50:1 with minimal visual loss of information. One of the main issues with ECW (and similar products) is the length of the time period between requesting a portion of image 42 and receiving the requested image portion. There are certain situations when new information is rapidly needed from the ECW file including when the zoom tool (step 321) or mouse wheel is used to change zoom level, when the hand tool (step 322) is used and/or the marker tool (step 323). The software holds in memory the last view displayed from ECW per window j.

This image, Iⱼ, is modified each time new information arrives from the ECW file, and its size is the same as the size of the window. The software also holds a copy of the full image with decreased resolution, usually, it is loaded from the jpeg file, but if the jpeg file is is missing, the image is calculated from the ECW file.

### Zoom Tool (Step 321):

When using the mouse wheel to zoom, the center of the image displayed will remain, In order to react quickly to a user action, the application will request the correct portion with the correct zoom to be displayed, but until this information arrives, the application preferably calculates sub image from I, to be displayed.

In the case of zooming in, the application takes I and enlarges it to fill the entire window. In the case of zooming out, the application takes I and calculates a smaller view of it to be displayed. In this case, the borders of the view are missing. When new information arrives the new information is displayed in the window. If another zoom action, e.g mouse wheel is turned, before ECW information arrival, the earlier request is aborted, a new request is processed and displayed from I.

### Hand Tool (Step 322):

When a user “drags” the view, a portion of the image I is copied and displayed in the right location, while waiting for ECW information. Again if, another interaction with the tool is done by user, the old request will abort a new request will be initialized and another calculation form I will be carried and displayed.

### Marker Tool (Step 323):

When using marker tool (step 323) on one window, all other windows choose (step 315) an image 42 to be displayed, and display (step 317) a respective images 42 in the windows according to current zoom level and window size. Preferably, images 42 of all windows are synchronized so that entity 44 is seen from different images 42 in all the windows. The user can use marker tool (step 323) for instance by either clicking on a window, or by moving the mouse in the window while the left button is held pressed. Both cases are the same in the manner, that the user needs to click on the mouse left button and then move the mouse (zero movement in the second case) and release the mouse button. When user clicks on the mouse button and as long as there is mouse movement, the software displays a decreased resolution version of the images. Finally when the user releases mouse button the software will request the information from the ECW files and display (step 317) What we gain by doing this is the speed in which the software reacts to using the tool, Of course, quality of the displayed view is less, which is more noticeable as zoom level increases. Preferably, if user holds the mouse button pressed, but does not move the mouse for short period of time, a request to ECW file is made, so the ECW is displayed.

### Image Choosing (Step 315) and Centering (Step 317):

When using marker tool 323, in one of the display windows, all the other display windows choose appropriate digital images 42 in each of the other display windows. Digital images are chosen (step 315) based on zoom level, and display window size.

According to embodiments of the present invention, all windows are synchronized so that the same entities 44 are visible from different digital images 42 in all the windows. Preferably, digital images 42 are chosen (step 315) to include all available views from different directions.

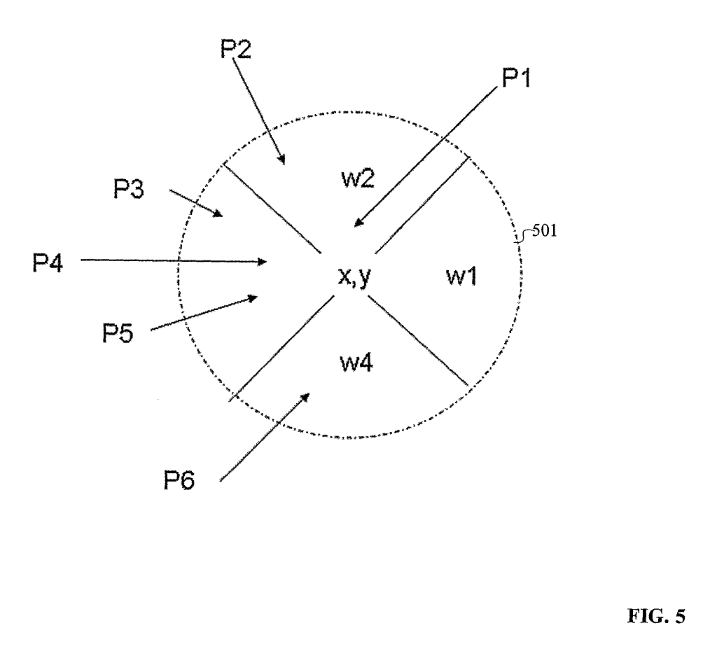

Reference is now made to FIG. 5, which illustrates a method of choosing (step 315) digital images 42, according to an embodiment of the present invention. Let n be the number of oblique windows, (n=4 in the example shown in FIG. 4b). The XY plane is virtually split into n pie pieces 501 and each piece 501 is fit to one of the display windows. The goal is to display images 42 in window i, such that images 42 were photographed from a camera direction P that falls into the ith piece 501 in the pie. Camera direction P is the direction from camera X_{c},Y_{c} to entity 44 of interest displayed in the center of the window, positioned in world coordinate Xₜ,Yₜ. In FIG. 5, six camera directions P1-P6 are shown for different stored oblique photographs. Only three of the four pie pieces 501 have appropriate directions. When using marker tool 323 on orthogonal image 40, the X,Y world coordinate is calculated by, a simple linear transformation, from mouse position, with respect to the current view, image portion, and current size of window. Our main concerns here are how to choose different oblique image 42 for each window, and for a given image and window calculate which image point should be displayed at the center of the window. When using marker tool 323 on oblique windows, first we need to find the image point to which the mouse cursor is pointing, this again is done by a simple transformation from mouse coordinate to image coordinate Xᵢ,Yᵢ. Then given Xᵢ,Yᵢ we need to find the matching terrain coordinate Xₜ,Yₜ. Once we have this, the process of choosing images 42 for other windows, and centering them is similar to the case of using marker tool 323 on orthogonal photograph 40. Assume that we have Xₜ,Yₜ geographic coordinate and wish to choose oblique images 42 to be displayed in a certain window. For each oblique image 42 in memory, the direction from camera position is calculated, X_{c},Y_{c} to Xₜ,Yₜ. If the camera direction suits the defined window direction than the distance from camera X_{c},Y_{c},Z_{c} to physical object Xₜ,Yₜ,Zₜ is calculated. Among all images 42, chosen image 42 will be the one with minimum distance. Once an image 42 is chosen, a center image coordinate Xᵢ,Yᵢ to is centered in the window by using the collinear equations to receive photograph coordinate Xᵢ,Yᵢ, and the interior orientation with Xₚ,Yₚ to receive image coordinate Xᵢ,Yᵢ The only remaining problem now is how to find terrain coordinate, Xₜ,Yₜ by giving an oblique image coordinate Xᵢ,Yᵢ. To solve this problem, we do the following: The average elevation of the DEM, Zₘ, is calculated in advance (in raster creation step 309) Xₚ,Yₚ is calculated by interior orientation from Xᵢ,Yᵢ. We calculate Xt₁,Yt₁ by using Zₘ,Xₚ,Yₚ in the collinear equations. By using the raster we calculate Zt₁ from Xt₁,Yt₁. If the absolute value of Zt₁−Zₘ is smaller than a certain threshold than Xt₁,Yt₁,Zt₁ is used. Otherwise we iteratively repeat the process with Zt₁,Xₚ,Yₚ this time receiving Xt₂,Yt₂,Zt₂ and checking the absolute value of Zt₂−Zt₁ and so on. The process usually converges after 4-5 iterations.

According to another embodiment of the present invention, image choosing (step 315) is performed using a special data base which is set up during pre-processing 31. For each oblique photograph stored in memory, a specific area in the shape of a trapezoid is covered on the stored orthogonal photographs/map. The trapezoidal shape arises from the perspective distortion of oblique images. An efficient data base structure is set up so that for a specific query including geographic coordinates X,Y, the data base returns the specific trapezoids that include X,Y.

### Layer Model:

According to embodiments of the present invention, the application maintains layers of information over images 40 and/or 42. A layer of information is overlaid and optionally displayed over oblique images 42. When a layer object is initialized, the object receives as a parameter the size of the underlying image 40 or 42. Each layer object currently can include for instance, lines, e.g. vectors, points and/or text. Preferably, layer data is read and displayed over a portion of the oblique image 42 using a minimum of processor time because the user frequently changes the viewed portion of image 42.

Each line in the system can be segmented or not segmented over the image. When segmented a vector is composed by n image lines where each image line has coordinates Xiⱼ,Yiⱼ,Xiⱼ₊₁,Yiⱼ₊₁ in image space, where 1≦j≦n. The vector is segmented to n world lines, each such line (except the last) Xwⱼ,Ywⱼ,Zwⱼ, Xwⱼ₊₁,Ywⱼ₊₁,Zwⱼ₊₁ has an air distance of 1 m, (this number can be changed to other values for different segmentation resolution) and transformed to Xiⱼ,Yiⱼ, Xiⱼ₊₁,Yiⱼ₊₁ by using exterior and interior orientations. Zwⱼ,Zwⱼ₊₁ are either taken from DEM or calculated from the line equation defined by line Xw₁,Yw₁,Zw₁, Xwₙ₊₁,Ywₙ₊₁,Zwₙ₊₁ depending on need. Image 42 is segmented by itself to 2D blocks and each image line is mapped to one or more blocks depending on its location in image space. If the image line falls in more than one block the image line is segmented to blocks by simply segmenting the image line to few pieces for matching blocks.

Displaying a portion of layer information, is performed by calculating and displaying blocks which are fully or partly visible on the current view. In this way, image lines that are referenced usually also need to be drawn. As the current zoom level is increased fewer blocks need to be drawn (fewer lines in the view) which gives high responsiveness to user requests to change the portion of image viewed. As zoom level decreases more blocks need to be drawn and when the view holds the entire image 42, all blocks should be drawn. In such a case many or all lines in the layer should be displayed and therefore responsiveness to user actions can suffer, depending on number of visible image lines. Preferably, to mitigate this problem when the application notices a user action with only a portion of image 42 viewed, while in the process of drawing a layer, the layer drawing process is aborted, and drawing of image 42 is processed instead. When zoom level is relatively high, aborting is not necessary, since the drawing is performed relatively quickly.

Alternatively, a relatively small raster image is be transparent in background and opaque with image lines. When the zoom level is relatively low, this raster can be drawn quickly over another image This method improves greatly the responsiveness to user actions, because drawing time does not longer depend on the number of lines in the layer. Notice that since the zoom level is low, accuracy of image lines coordinates is of less importance. A disadvantage to this method is the fact that this raster must be updated when layer information is changed. For example when user deletes/adds line from/to the layer.

### Layers Organization:

Layers are organized in blocks. Each block contains one or more layers. The blocks are ordered, and also layers inside each block are ordered When image 42 is loaded, image 42 is initialized to hold only one block, a system layer that cannot be deleted by the user. Preferably, the user is able to import and associate one or more dxf files with image 42. When the dxf file is imported all layers in the file are loaded to a new block. This method of layers organization enables easy manipulation of the following features: Hiding/Displaying all layers of certain block, changing the painting order of blocks and layers inside blocks, removing a layer or a complete block of layers, exporting blocks of layers to a file, removing a certain block.

For example, to achieve changing the painting order, we need only to change the order in which blocks of layers are organized in memory.

### Layers Painting:

When new information arrives from ECW file, layers information is preferably displayed over image information, and then displayed in the display window. The process of painting is performed in the following manner: The ECW information arrives and painted to a bitmap B₀. Each layer i, in turn, is painted over bitmap Bᵢ₋₁.

When the user uses the hand tool or the zoom tool, new information is requested from the ECW file. In the time between the request and the arrival of image information, the image model described above is used to paint the window with a temporary image that is constructed from the last information that arrived from the ECW file

Assume new information is arriving with a specific zoom level; this information is at least a portion of the full image. The upper left coordinate on the arriving image portion is taken from the full image at coordinate tlx,tly and the bottom left is taken from coordinate brx,bry these coordinates with certain zoom level were requested from ECW previously.

In order to be react quickly to user requests for instance while the user is rapidly using the hand tool, layers should be painted quickly. If layers information is large and zoom level is low considerable time is required.

A number of techniques are used to reduce this time delay and to improve reaction to user requests:

Layer painting is performed according to blocks that are visible in the requested view. This means that most objects that are going through iteration when the layer is in painting process, are actually objects that should be painted eventually. Exceptions to this rule are objects that fall in partially visible image blocks.

When the view requested occupies a relatively big portion of the complete image (i.e brx−tlx>c₁, bry−tly>c₂) and the user interacts with the tools above, layer painting process is stopped, and the view is painted with layers that were painted so far.

When the view requested occupies relatively small portion of the complete image, (i.e brx−tlx<c₁, bry−tly<c₂) usually only small amount of layers information is needed, therefore painting is processed quickly and stopping the painting process is not necessary.

In order to achieve even better results (from a user point of view) another raster image per image should be maintained to hold a complete drawing of the layer. This raster image should be relatively small in size (one way is to use the jpeg size), and should be constantly edited when the layer is behind edited—an object is added, deleted or edited.

Each layer can use its raster for painting instead of iterating through many image blocks, which potentially might contain many objects. The raster image should be with transparent background, so painting such an image over another image will paint only the entities.

### System Layers for Measuring Tools (Step 319):

The following measurements (step 319) are performed according to embodiments of the present invention each in a different layer: horizontal measurements, vertical measurements, vertical rectangle measurements, terrain segmented measurements, air distance—horizontal and diagonal measurements. For each of the layers, there is a specific tool that is used to insert new lines to the respective layer. Reference is now made again to FIG. 4b. The user wishes to perform a horizontal measurement between image points 403 and 405, according to an embodiment of the present invention. Three selections, e.g. mouse clicks are performed to achieve the horizontal measurement. A ground point 407 is selected on the ground below the image point 403. The second mouse click is on image point 403, and the third mouse click is on image point 405. The first click is used to determine the terrain coordinates X₁,Y₁,Z₁ on ground point 407 below the image point 403. When the first click is performed, a vertical line 409 preferably appears that begins from the X₁,Y₁,Z₁ and extends vertically upward. Since X₁,Y₁ is known after first click, calculating vertical line 409 is performed by using the collinear equations n times, each time with X₁,Y₁,Zᵢ where Zᵢ=Z₁+Δz·i, to receive Xpᵢ,Ypᵢ (Δz is a small constant) The second click is on vertical line 409. When clicked we have the image coordinates Xi₂,Yi₂, which are transformed to Xp₂,Yp₂ by using the interior orientation. Now we use Xp₂,Yp₂ and X₁,Y₁ in C.E to receive Z₂ (the height of the image point 403). Now we have X₁,Y₁,Z₂ which are the world coordinates of image point 403. The third click is on image point 405 and gives us Xi₃,Yi₃. Again using interior orientation we receive Xp₃,Yp₃. we use Xp₃,Yp₃ and Z₂ with C.E to receive the world coordinates X₃,Y₃,Z₂ of image point 405. Notice that we use Z₂ on the second measured coordinate. This is a good assumption when we deal with small distances that are known to be horizontal.

A vertical measurement, according to an embodiment of the present invention is performed similarly to the horizontal measurement. The user wishes to vertically measure between image point 413 and image point 415. The user first selects, e.g. by mouse click on an image point 411 on the ground vertically below image points 413 and 415. The world coordinates of ground point 411 are calculated using the collinearity equations. Vertical line 409 is displayed in a layer over image 42S. The user then selects image point 413 followed by image point 415. The X,Y world coordinate is the same for all 3 clicks, and in the second and third click, we calculate only elevations from this coordinate (in similar manner to the horizontal tool)

A vertical rectangle measuring tool is used to measure small rectangles that are known to be vertical to the terrain (e.g measuring street signs) Four image point selections are required with the first selection on the ground. The three first selections are the same as in the vertical measurement The first click on the ground brings up vertical line 409 and second and third click are on vertical line 409 for instance on corners of a street sign. The fourth click, for instance on another corner of the street sign calculates all the world coordinates of the street sign.

A terrain measuring tool is used to measure terrain distances. Two selections are on two image points on the terrain. Terrain coordinates X₁,Y₁,Z₁, X₂,Y₂,Z₂ are calculated. A new line is inserted into the layer with segmentation over the terrain, the distance of each segment is calculated summed up to find the length of the path.

An air distance measure tool is used to calculate air distances between two coordinates. Two image point selections are used. Terrain coordinates X₁,Y₁,Z₁, X₂,Y₂,Z₂ are calculated for the selections. Air distance X₁,Y₁−X₂,Y₂ is calculated for the horizontal air layer and the distance X₁,Y₁,Z₁−X₂,Y₂,Z₂ is calculated for the diagonal air layer.

According to embodiments of the present invention, world coordinates are accurately obtained by selecting on different images 42 synchronized image points which have the same world coordinates, and calculating simultaneously using the two or more sets of collinearity equations, for the world coordinates. For example, referring again to FIG. 4b, the user selects the point of the cone on entity 44S. and 44W. Two sets of collinearity equations are solved simultaneously to accurately determine the world coordinates of the point of the cone.

### Build Layer Object (Step 325)

After the process of the orientations, i.e. 3D photogrammetric model is complete we can use the model for measuring facades and building layer objects (step 325) in the photograph, by defining a discrete function from world coordinates to the matching image coordinates.

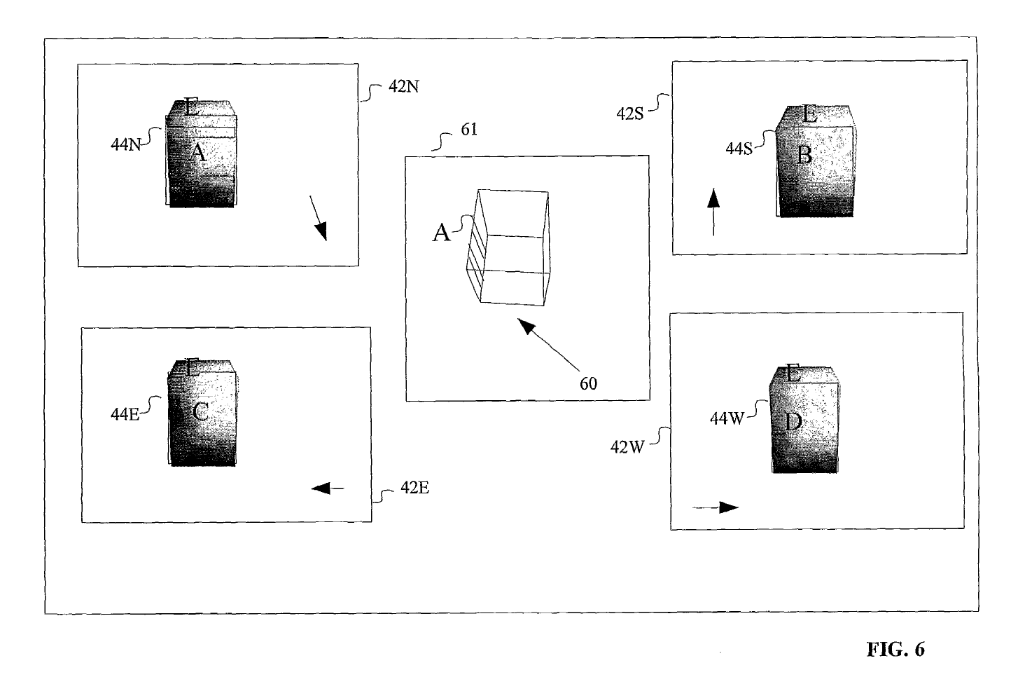

Reference is now made to FIG. 6 which shows a simplified example of building (step 325) a layer object 60, according to an embodiment of the present invention. Preferably, the window showing the orthogonal photograph 40 is closed or placed in the background. A new display window 61 is opened. Window 61 is scaled according to geographic coordinates. Different facades of entity 44 are labeled with letters A-E. A layer object such as a rectangle is displayed obliquely over each facade. When the layered rectangle coincides with the facade, the layered rectangle is copied to window 61. By repeating for all facades A-E, layered object 60 is built (step 325).

### Cropping Facades (Step 333)

The cropping of facades is available, since the facade polygon in world coordinates is mapped into a polygon in image space. The polygon may be be cropped if the world coordinates of the vertices of the polygon are known. In FIG. 6, facade A is cropped (step 333) and pasted (step 335) onto layer object 60.

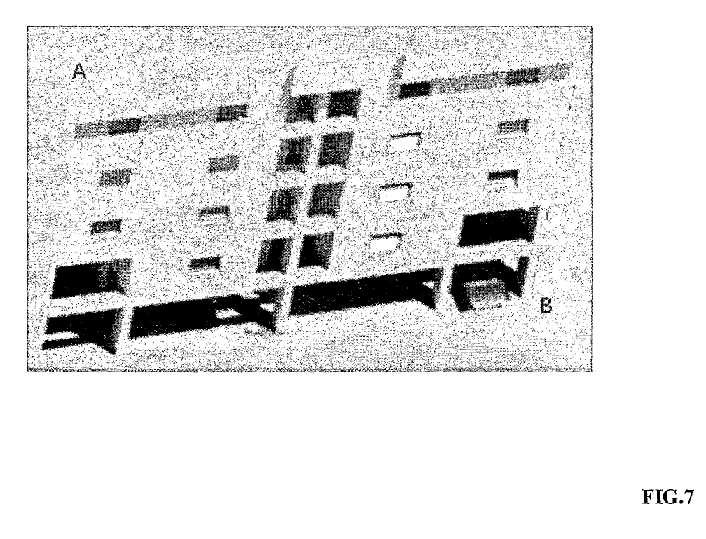

FIG. 7 shows an example of a cropped facade taken from an oblique image. Points A and B are vertices with known world coordinates, and since this facade is a rectangle in the real world, knowing A,B is sufficient for knowing the entire facade location. The cropped facade is saved to an image file such as bitmap (bmp), jpeg (jpg) or tiff. Together with the image file the world coordinates of the vertices are saved creating the facade.

Handling a single facade is relatively straightforward, but what about cropping (step 333) the facades of entire building? What is a building? A building is a group of facades connected together. For any given photograph, some of the facades of some buildings are occluded by others. Therefore for a complete model, multiple photographs are required from all directions of the buildings. Assuming we have all the required images from all directions with the orientations known. One can measure facades in each of the images and crop the “best” facade from each image or direction.

In real life not everything is exact, in our case there could be small errors in orientations and positions between images 42. Moreover, even if the orientations are exact, ability to measure facades with high accuracy is limited due to photograph quality, resolution and even mouse click errors. A mouse click error of one pixel of the image can represent a significant area in the real world. If the user measures facades from different photographs the facades will often not connect to each other. There will be gaps between each two neighboring facades. In order to avoid gaps in the virtual model, it is preferable, to build (step 325) layer object 60 prior to cropping facades (step 333) by preserving connectivity between all the facades that are connected in the building. In this way, systematic and/or random errors in process 30 are averaged out or minimized as best as possible.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

While the invention has been described with respect to a limited number of embodiments, it will be appreciated that many variations, modifications and other applications of the invention may be made.

What is claimed is:

1. A method for processing in a computer a plurality of digital images stored in the computer, the digital images being derived from a plurality of respective photographs of a geographic region, wherein the photographs were photographed from a plurality of directions, the method comprising the steps of:
(a) displaying a first image of said digital images, said first image corresponding to a first photograph of the photographs; wherein said first photograph was photographed at an oblique angle;
(b) simultaneously displaying at least one other of the digital images corresponding to at least one other of the photographs; and
(c) upon selecting an image point in said first image, synchronizing a corresponding image point in at least one other of the digital images, wherein said selected image point in said first image and said corresponding synchronized image point in said at least one other image have substantially identical world coordinates.

2. The method, according to claim 1, further comprising the step of, prior to said selecting and said synchronizing, for at least one of the respective digital images:
(d) calculating camera coordinates of said at least one photograph based on at least three control points in said at least one respective digital image, wherein geographic coordinates of said at least three control points are previously known.

3. The method, according to claim 1, further comprising the step of:
(d) simultaneously calculating said world coordinates for said image point and said corresponding image point.

4. The method, according to claim 1, further comprising the step of:
(d) creating an exportable object by selecting at least one other image point in at least one of said displayed digital images.

5. The method, according to claim 1, wherein said selecting and said synchronizing include the step of iteratively estimating geographic coordinates of said selected image point, wherein an estimated elevation value is received from a digital elevation model of the region based on said estimated geographic coordinates, wherein said digital elevation model is previously stored in memory of the computer, wherein respective camera coordinates of said first photograph and said at least one other photograph are previously determined.

6. The method, according to claim 1, further comprising the step of:
(d) storing a raster digital elevation model in memory of said computer, wherein upon inputting any geographic coordinates to said raster digital elevation model, said raster digital elevation model returns a corresponding elevation value.

7. The method, according to claim 6, further comprising the steps of, prior to said selecting and said synchronizing, for at least one of the digital images and at least one of the respective photographs:
(e) selecting at least three control points in said at least one digital image, wherein respective geographic coordinates of said at least three control points are previously determined and respective elevation values are obtained from said raster digital elevation model; and
(f) calculating camera coordinates of the camera which photographed said at least one photograph based on said at least three control points.

8. The method, according to claim 1, further comprising the steps of:
(f) determining a photograph direction of at least one of the digital images, wherein said photograph direction is substantially determined by a vector between a camera position of said at least one digital image to said selected image point; and
(e) choosing from the plurality of digital images at least one of the digital images wherein said choosing is based on comparing a geographic direction to said photograph direction.

9. The method, according to claim 1, further comprising the step of:
(d) performing a measurement in at least one of said displayed images between a first image point and a second image point, wherein said performing includes the sub-steps of:
(i) selecting an image ground point below said first image point;
(ii) calculating at least one world coordinate in a vertical line segment, wherein said vertical line segment extends vertically from said image ground point; and
(iii) upon selecting said first image point on said vertical line segment, calculating at least one world coordinate at said first image point based on said at least one world coordinate in said vertical line segment.

10. The method, according to claim 9, wherein said measurement is a horizontal distance measurement, said performing further includes the sub step of:
(iv) upon selecting said second image point, calculating geographic coordinates of said second image point.

11. The method, according to claim 9, wherein said measurement is a vertical distance measurement, said performing further includes the sub step of:
(iv) upon selecting said second image point, calculating an elevation of said second image point.

12. The method, according to claim 1, wherein said selected image point is on a three dimensional entity at least partially visible in said first image, wherein said displaying and said simultaneously displaying show a plurality of different views from different directions of said three dimensional entity, the method further comprising the step of:
(d) selecting in at least one of said displayed images a plurality of other image points on said three dimensional entity, thereby synchronizing said other image points in said at least one displayed image, and displaying a three dimensional object over said three dimensional entity.

13. A method for performing a measurement related to an image point in a digital image using a computer which stores and displays the digital image, the digital image being derived from a photograph taken at an oblique angle, the method comprising the steps of:
(a) selecting an image ground point below said first image point;
(b) calculating at least one world coordinate in a vertical line segment, wherein said vertical line segment extends vertically from said image ground point; and
(c) upon selecting said first image point on said vertical line segment, calculating at least one world coordinate at said first image point based on said at least one world coordinate in said vertical line segment.

14. The method, according to claim 13, further comprising the step of:
(d) displaying said vertical line segment over said one displayed image.

15. The method, according to claim 13, wherein said calculating includes iteratively estimating geographic coordinates, wherein an estimated elevation value is received from a digital elevation model based on said estimated geographic coordinates, wherein said digital elevation model is previously stored in memory of the computer, wherein respective camera coordinates of said photograph are previously determined.

16. The method, according to claim 13, further comprising the step of
(d) upon selecting a second image point related to the measurement, calculating at least one world coordinate of said second image point.

17. A method for building three dimensional models in a computer, wherein a plurality of digital images are stored in the computer, the digital images being derived from a plurality of respective photographs of a geographic region, wherein the photographs were photographed from a plurality of directions, the method comprising the steps of:
(a) choosing from the plurality of stored digital images a plurality of displayed digital images and simultaneously displaying said displayed digital images each including at least a partial view from a different direction of a three dimensional entity;
(b) selecting in at least one of said displayed digital images a plurality of image points on said three dimensional entity, thereby synchronizing other image points in at least one other said displayed digital image, and thereby displaying a three dimensional object.

18. The method, according to claim 17, wherein said image points include a plurality of vertices of a plurality of facades of said three dimensional object, further comprising the step of:
(c) building said three dimensional object while preserving connectivity of at least two said facades displayed in at least two said displayed digital images.

19. The method, according to claim 17, wherein said image points include a plurality of vertices of a plurality of facades of said three dimensional entity, further comprising the step of:
(c) cropping said facades as respective polygons with said vertices, by calculating at least one world coordinate respectively of said vertices;
(d) pasting at least one said facade onto said three dimensional object, thereby incorporating said facade in said three dimensional object.

20. The method, according to claim 17, further comprising the steps of:
(c) exporting said three dimensional object to selectably either a new display window or another application of the computer.

21. The method, according to claim 17, wherein for at least one said image point, further comprising the steps of:
(c) selecting an image ground point below said at least one image point;
(d) calculating at least one world coordinate in a vertical line segment, wherein said vertical line segment extends vertically from said image ground point; and
(e) upon selecting said at least one image point on said vertical line segment, calculating at least one world coordinate at said at least one image point based on said at least one world coordinate in said vertical line segment.

22. The method, according to claim 17, wherein for at least one said image point, further comprising the step of:
(c) iteratively estimating geographic coordinates of said at least one image point, wherein an estimated elevation value is received from a digital elevation model of the region based on said estimated geographic coordinates, wherein said digital elevation model is previously stored in memory of the computer, wherein respective camera coordinates of said photographs are previously determined.

23. A program storage device readable by a machine, tangibly embodying a program of instructions executable by the machine to perform a method for processing in a computer a plurality of digital images stored in the computer, the digital images being derived from a plurality of respective photographs of a geographic region, wherein the photographs were photographed from a plurality of directions, the method comprising the steps of:
(a) displaying a first image of said digital images, said first image corresponding to a first photograph of the photographs; wherein said first photograph was photographed at an oblique angle;
(b) simultaneously displaying at least one other of the digital images corresponding to at least one other of the photographs; and
(c) upon selecting an image point in said first image, synchronizing a corresponding image point in at least one other of the digital images, wherein said selected image point in said first image and said corresponding synchronized image point in said at least one other image have substantially identical world coordinates.

24. A program storage device readable by a machine, tangibly embodying a program of instructions executable by the machine to perform a method, for performing a measurement related to an image point in a digital image using a computer which stores and displays the digital image, the digital image being derived from a photograph taken at an oblique angle, the method comprising the steps of:
(a) selecting an image ground point below said first image point;
(b) calculating at least one world coordinate in a vertical line segment, wherein said vertical line segment extends vertically from said image ground point; and
(c) upon selecting said first image point on said vertical line segment, calculating at least one world coordinate at said first image point based on said at least one world coordinate in said vertical line segment.

25. A program storage device readable by a machine, tangibly embodying a program of instructions executable by the machine to perform a method for building three dimensional models in a computer, wherein a plurality of digital images are stored in the computer, the digital images being derived from a plurality of respective photographs of a geographic region, wherein the photographs were photographed from a plurality of directions, the method comprising the steps of:
(a) choosing from the plurality of stored digital images a plurality of displayed digital images and simultaneously displaying said displayed digital images each including at least a partial view from a different direction of a three dimensional entity;
(b) selecting in at least one of said displayed digital images a plurality of image points on said three dimensional entity, thereby synchronizing other image points in at least one other said displayed digital image, and thereby displaying a three dimensional object.
